(19) United States
(12) Patent Application Publication
(10) Pub. No.: US 2023/0140410 A1
(43) Pub. Date: May 4, 2023

(54) INCIDENT MANAGEMENT ESTIMATION FOR DATA WAREHOUSES

(71) Applicant: INTERNATIONAL BUSINESS MACHINES CORPORATION, ARMONK, NY (US)

(72) Inventors: Pranshu Tiwari, Delhi (IN); Swarnalata Patel, MORRISVILLE, NC (US); Harish Bharti, Pune (IN); Saurabh Trehan, Gurgaon (IN)

(21) Appl. No.: 17/512,719

(22) Filed: Oct. 28, 2021

(51) Int. Cl. G06Q 10/06; G06N 5/00; G06N 20/00

(52) U.S. Cl. CPC G06Q 10/063112; G06Q 10/063114; G06N 5/003; G06N 20/00

(57) ABSTRACT

A method includes receiving, by one or more processors of a computer system, historical data related to deployment characteristics and an architecture for past incidents occurring in a data warehouse, predicting, by the one or more processors of the computer system using neural network modeling, tickets related to a response to at least one incident occurring in the data warehouse, wherein the predicting is based on the deployment characteristics and the architecture of the data warehouse, considering, by the one or more processors of a computer system, a plurality of parameters to ascertain the predicted tickets, and providing, by the one or more processors of the computer system, incident ticket volume prediction including the predicted tickets to an incident management system interface reviewable by a user.

### BACKGROUND

The present invention relates to incident management estimation processes for data warehouses. More specifically, the invention relates to using information technology systems with data warehouses and which store business data. These systems are often highly critical to support business operations. Thus, the planning and incident management of data warehouses is critical but daunting task for any information technology enterprise.

### SUMMARY

According to embodiments of the present invention, a method, and associated computer system and computer program product for incident management estimation for data warehouses is provided. One or more processors of a computer system receive historical data related to deployment characteristics and an architecture for past incidents occurring in a data warehouse. The one or more processors of the computer system use neural network modeling to predict tickets related to a response to at least one incident occurring in the data warehouse, wherein the predicting is based on the deployment characteristics and the architecture of the data warehouse. The one or more processors of the computer system consider a plurality of parameters to ascertain the predicted tickets. The one or more processors of the computer system provide incident ticket volume prediction including the predicted tickets to an incident management system interface reviewable by a user.

### BRIEF DESCRIPTION OF THE DRAWINGS

FIG. 1 depicts a system for estimation of incident management in a data warehouse, in accordance with embodiments of the present invention.

FIG. 2 depicts a process flow for modeling and simulation for the system for estimation of incident management in a data warehouse of FIG. 1, in accordance with embodiments of the present invention.

FIG. 3 depicts an architectural pattern for the system for estimation of incident management in a data warehouse of FIG. 1 for which incident management estimates are created, in accordance with embodiments of the present invention.

FIG. 4 depicts an alternative architectural pattern for system for estimation of incident management in a data warehouse of FIG. 1, in accordance with embodiments of the present invention.

FIG. 5 depicts a component decomposition for the system for estimation of incident management in a data warehouse of FIG. 1 which is used in estimates, in accordance with embodiments of the present invention.

FIG. 6 depicts a scatter plot of historical deployments of the system for estimation of incident management in a data warehouse of FIG. 1, in accordance with embodiments of the present invention.

FIG. 7 depicts a scatter plot of deployment characteristics and tickets supported, in accordance with embodiments of the present invention.

FIG. 8 depicts detailed method of how a solution estimate works based on past data, in accordance with embodiments of the present invention.

FIG. 9 depicts a block diagram of an exemplary computer system that may be included in the system estimation of incident management in a data warehouse of FIG. 1, capable of implementing process flows and methods estimation of incident management in a data warehouse of FIGS. 2 and 8, in accordance with embodiments of the present invention.

FIG. 10 depicts a cloud computing environment, in accordance with embodiments of the present invention.

FIG. 11 depicts abstraction model layers, in accordance with embodiments of the present invention.

### DETAILED DESCRIPTION

Enterprises or institutions of today depend on many information technology systems and applications. A majority of the enterprises (business, academic, nonprofit, etc) or institutions have their own data warehouse and operational systems which stores trillions of business and operational data. Present systems are highly critical to support the business or enterprise operations. Incident planning and mean time for resolution are important variables for proper support planning and determining a post deployment model. To predict incident tickets for large and complex data warehouse and operational systems is a daunting task due to system integration and several other complexities. The present invention solves this need to create a system and method to study, analyze and predict volume of incident tickets, for data warehousing applications to optimize the ticket resolution time given the cost constraint of the client.

The present systems and methods estimation of incident management in a data warehouse described herein provide end to end framework to provide wisdom to optimize and scale up resources to support data warehousing applications. Once it is possible to predict the volumes—systems and methods estimation of incident management in a data warehouse described herein recommend necessary resources, skill sets, cost to support the applications.

The inventive solution described herein focus on some of the historical deployment attributes assessment of ticket volume from similar deployments for data warehouse applications. Data warehouse architecture data may include information related to personal skills and qualification handling tickets, mean time to resolve tickets, identification of potential problems that caused the incidents, business user volume and growth, application integration complexity based on Cyclomatic Complexity (CC) analysis of similar deployments, proportion of the number of events of each type of failure, the type of data warehouse architecture, disaster recovery strategy and the like.

Systems and methods for estimation of incident management in a data warehouse described herein include using a regression model that is capable of calculating a response of the independent data variables that will predict ticket volume and/or growth. Once it is possible make a prediction, systems and methods for estimation of incident management in a data warehouse described herein use meta heuristics to map key characteristics required to optimize the time taken to resolve the incident tickets.

Expected user ticket volume and system downtime/outage prediction are important aspects associated with data warehouse software application support and maintenance. Thus, systems and methods estimation of incident management in a data warehouse described herein develop a framework which predicts ticket volumes, predict mean resolution time to resolve high severity tickets and identify characteristics needed to reduce and/or optimize the mean resolution time of tickets across various data warehouse applications.

Systems and methods estimation of incident management in a data warehouse described herein may be applicable to various architectural patterns, and the architectural patterns with various different types of high level characteristics. Depending on the characteristics of the architectural pattern of the data warehouse, systems and methods estimation of incident management in a data warehouse described herein may be configured to use different type of modeling. For example, for a centralized corporate data warehouse architecture or independent data mart architecture, linear or log linear modeling may be used for the prediction of tickets. In contrast, for a federated architecture, hub-and-spoke architecture, data-mart bus, data lake or virtual logical data warehouses, penalized regression may be preferred for the prediction of tickets. Systems and methods estimation of incident management in a data warehouse described herein may leverage heuristics models such as a multi-start naïve approach, a gradient approach and a Lagrange multiplier approach. Any of these types of architectures may utilize a digital tree (TRIE data structure) for finding resources. Specific examples of using these modeling approaches are described herein below.

Systems and methods estimation of incident management in a data warehouse described herein predict the volume of tickets for a new deployment, necessary resources needed to reduce the mean resolution time for incident management and provide for a recommendation system to recommend the right resources for lowering the application support cost given the constraints of a client, customer, or user data warehouse.

For the green field implementation, systems and methods estimation of incident management in a data warehouse described herein focus on the historical deployment attributes from similar deployments for previous known data warehouse applications which have available data related thereto.

Systems and methods estimation of incident management in a data warehouse described herein provide end-to-end framework that provides solutions for data warehouse application support and may be supported by either a cloud model or traditional and event driven data warehouse model. Systems and methods herein consider the given client, customer or user data warehouse using past experience and considers actual estimates for data warehouse application support by particularly considering parameters such as:
Assessment of ticket volume from similar deployments against different architecture patterns and kind of users
Number of users, performance characteristics, number of Integrations, and/or number of data marts
Mean time to resolve tickets given resource categories and skill set range
Potential problems that cause incidents
Business User volume and growth
Client budget Range
Skill Set Range

Systems and methods estimation of incident management in a data warehouse described herein may parametrize the Predicted Volume of tickets as a dependent variable based on linear or non-linear models depending on accuracy for traditional data warehouse or event driven hybrid messaging. The models described herein may consider following independent variables:
Type of users—(Miner, explorer, farmer, operator, tourist, etc.)
Cyclomatic Complexity
Performance Time-Elapsed
Architecture Type supported by a client customer or user data warehouse
Number of interactions
Number of transactions
Data size

Systems and methods estimation of incident management in a data warehouse described herein may be configured to estimate time to resolve tickets through parametrizing the resource constraints/resource types including:
Cost of Resource
Skill Set, intricate skill in each cloud in multi-cloud environment
Collaboration Assessment
Qualification
Cost

Systems and methods estimation of incident management in a data warehouse described herein provide a model which automatically optimizes and/or minimizes the cost of Project to find optimum resource-experience cost mix given the client constraints leveraging various heuristics models, such as a Multi—Start Naïve Approach, a Gradient Approach and/or a Lagranges Multiplier approach, as described herein below.

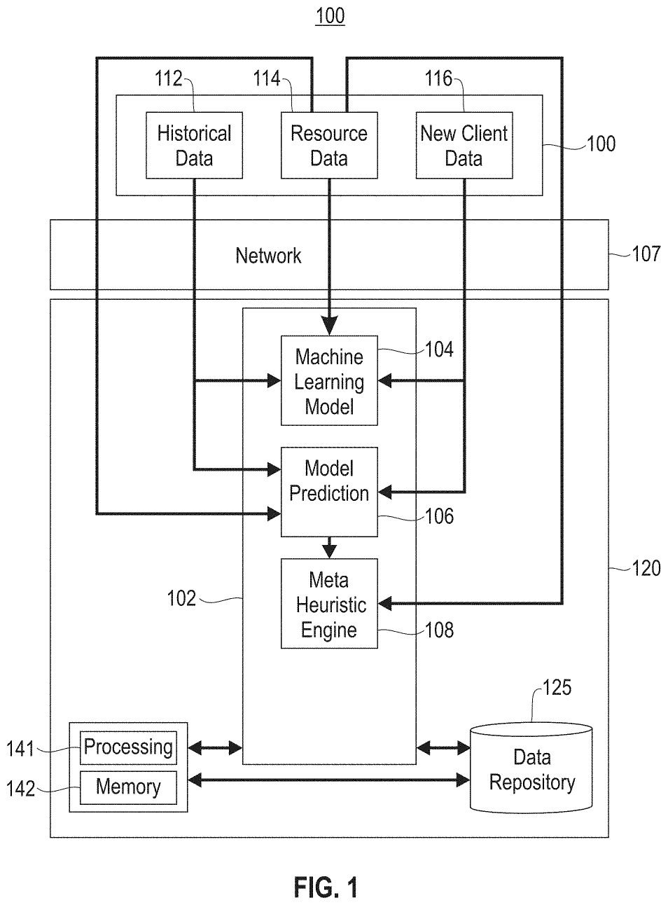

FIG. 1 depicts a system for estimation of incident management in a data warehouse 100, in accordance with embodiments of the present invention. The system estimation of incident management in a data warehouse 100 may include a data warehouse 110 connected over a network 107 to a computer system 120. The computer system 120 may include an analytics platform 102 that includes a machine learning model assessment module 104, a model prediction module 106, and a meta heuristic engine module 108.

The data warehouse 110 may be any type of data warehouse known in the art, and may include a data collection area connected to the network 107. The data warehouse 110 may include one or more servers and racks connected to a data center for storing and collecting data. The data warehouse 110 may include one or more buildings, information technology equipment, electrical infrastructure, backup generators, cooling equipment, automatic transfer switches, power distribution units, and the like. The data warehouse 110 may be configured to receive data transmitted back and forth between various nodes or connected devices that are accessible to the network 107 (not shown). The data warehouse 110 may be configured to selectively store data from various devices or systems connected to the network 107. For example, the data warehouse 110 may save and catalogue user data sent over user devices on a given platform.

Whatever the embodiment, the data warehouse 110 may include sources of data which are provided to the analytics platform 102 of the computer system 120 for the purpose of performing the various functionality described herein. Thus, the data warehouse 110 may include historical data 112 configured to be provided to the machine learning model assessment module 104 and the model prediction module 106. The data warehouse 110 may further include resource data 114 (including resource characteristic data) that is configured to be provided to each of the modules 104, 106, 108 of the analytics platform 102. The data warehouse 110 still further includes new client data 116 configured to be provided to the machine learning model assessment module 104 and the model prediction module 106.

The network 107 may be any group of two or more computer systems linked together. The network 107 may represent, for example, the interne. The network 107 may be any type of computer network known by individuals skilled in the art. Examples of computer networks which may be embodied by the network 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network 107 may be a peer-to-peer network in some embodiments, wherein in other embodiments, the network 107 may be organized as a client/server architecture.

Embodiments of the computer system 120 may include the machine learning model assessment module 104, the model prediction module 106, and the meta heuristic engine module 108. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the machine learning model assessment module 104 may include one or more components of hardware and/or software program code for taking the historical data and resource data and using machine learning algorithms for creating models with macine learning and assessing created models. Embodiments of the model prediction module 106 may include one or more components of hardware and/or software program code for predicting one or more appropriate created model given a particular set of new client data or a given set of circumstances or parameters. Embodiments of the meta heuristic engine module 108 may include one or more components of hardware and/or software program code for providing mathematical optimization using an appropriate model in order to both determine which model of the predicted models from the model prediction module 106, and also optimize the predicted model.

Referring still to FIG. 1, embodiments of the computer system 120 may be equipped with a memory device 142 which may store the information related to the data warehouse 110 used by the analytics platform 102. The computer system 120 may further be equipped with a processor 141 for implementing the tasks associated with the system estimation of incident management in a data warehouse 100.

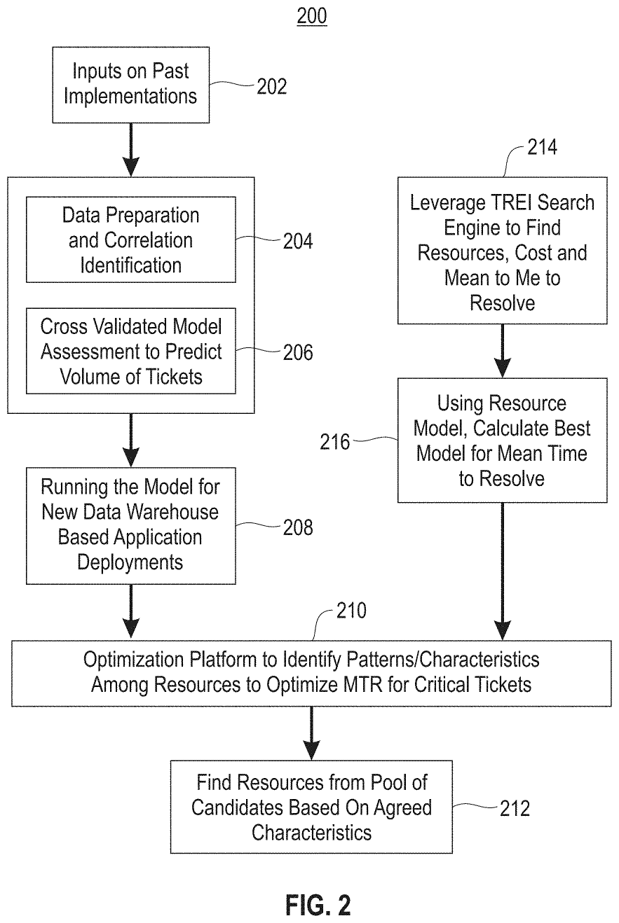

FIG. 2 depicts a process flow 200 for modeling and simulation for the system for estimation of incident management in a data warehouse 100 of FIG. 1, in accordance with embodiments of the present invention. In a first step 202, inputs on past implementations may be provided to the analytics platform 102 of the computer system 120 by, for example, the historical data 112 of the data warehouse 110. The analytics platform 102 may be configured to take the historical data 112 inputs on past implementations and/or incidents and perform both data preparation and correlation identification 204 and a cross validated model assessment to predict a volume of tickets 206. From here, the model or models generated by the inputs on past implementations 202 is used by running the model or models for a new data warehouse based application deployments or incidents 208. From here, the model or models may be optimized at a process step 210. The optimization may identify patterns or characteristics among resources to optimize the response (e.g. a mean time to resolution) for critical tickets, for example. Additionally, the analytics platform 102 may be configured to find resources from a pool of candidates based on agreed upon characteristics at a step 212.

In addition to predicting ticket volume, the analytics platform 102 may be configured to leverage a TREI search engine to find resources, cost and mean time to resolve tickets, at a step 214. Still further, the analytics platform 102 may be configured to use a resource model (e.g. a meta heuristic model) to calculate the best model for mean time to resolve, at a step 216. Once the best model for mean time to resolve has been calculated, this may also be optimized at the step 210, and then candidates may be found from a pool at the step 212.

Thus, the three primary stages of the present systems and methods estimation of incident management in a data warehouse described herein include: 1) prediction of tickets for new deployments based on deployment characteristics and architecture; 2) finding resources and creating a ticket resolution time response function; and 3) finding the characteristics which will minimize ticket resolution time.

In the first of the above three stages, various data attributes may be used. For example categorical variables may include the type of architecture (traditional data warehouse or event driven hybrid messaging), type of users (miner, explorer, farmer, operator, tourist), retrieval strategy (large/small data retrieval, retrieval from a single data block or many blocks), type of interactions (analytical, statistical, informational, etc.), type of data presentation (adhoc reports, heavy queries, analytics, data mining), type of data marts (independent or dependent), source of ETL data (legacy system, heterogeneous data structure (structure/unstructured, network/hierarchical databases, tape, archive data, etc.), size of data block, type of events, and type of message system (distributed or fully managed cloud based API messaging service). Continuous variables may include cyclomatic complexity, performance time-elapsed, number of integrations number of data marts, number of transactions in time period, number of technical components (data acquisition, data storage, information delivery) number of events, number of event producer applications, number of event consumer applications, and number of message systems.

In the first of the above stages, the prediction of tickets for new deployments may require the measurement of dependencies between variables. A variance inflation factor (VIF) may be calculated. Further, pattern of the error rate may be calculated. With these calculations, described in more detail below, the volume of tickets may be determined. Transition calculations at this stage may include selecting the best lambda for feature selection using grid search optimization that leverages elastic net regression and/or ridge regression. This stage may be accomplished by choosing the best model (i.e. minimized cross validated error) using cross validated data for multiple models (e.g. linear regression, generalized additive model(s), log linear regression and/or stochiastic gradient models) after feature selection.

The second of the above stages of finding resources and creating a ticket resolution time and response function, data attributes may include skill qualification, time taken, tickets and resource(s). Here, the time taken per resource, probability of severity of tickets, average cost, and average ticket resolution time may be determined. Transition calculations at this stage include using TREI algorithms, and/or using correlation matrix and regression and/or penalized regression.

The third of the above stages of finding the characteristics which will minimize ticket resolution time, data attributes may include probability of severity of tickets, volume of tickets, and average time taken by a pool of resources. The overall cost of predicted work may be determined during this stage. In the case of a continuous function, a minima/maxima model may be used. A gradient search method, multi-start approach to minimize mean time to resolution (MTR). Additionally, cost, qualification and skill set calculations may be performed.

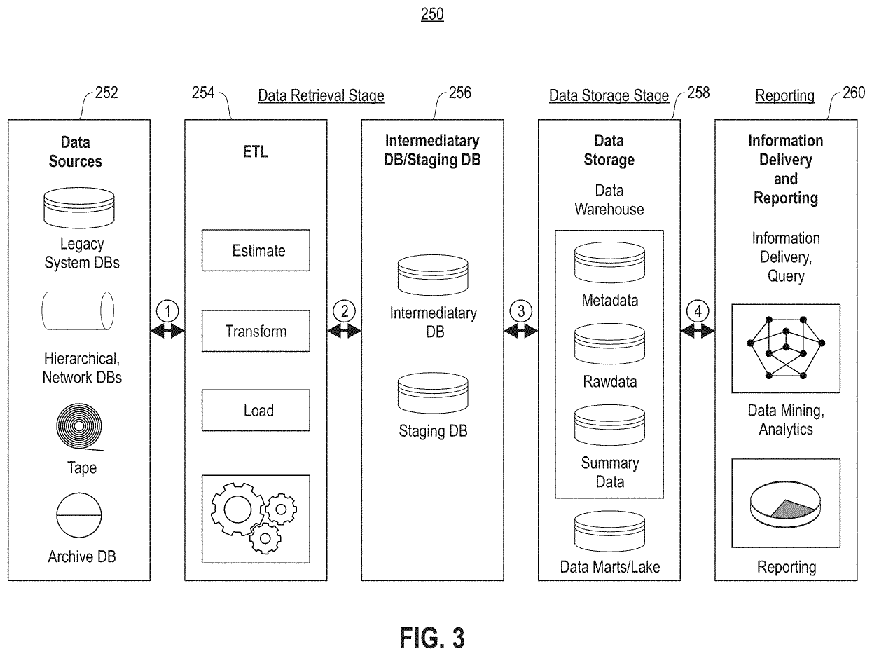

FIG. 3 depicts an architectural pattern 250 for the system estimation of incident management in a data warehouse 100 of FIG. 1, in accordance with embodiments of the present invention. While exemplary architectural patterns and component decompositions are shown in FIGS. 3-5, it should be understood that the estimation processes of the present invention may be configured to work for any type of data warehouse architectural pattern or component decomposition. In this architectural pattern, a data retrieval stage includes first compiling data sources 252 which may include many types, including legacy system databases, hierarchical network databases, tape, archived databases, flat file and the like. The data sources 252 may be provided to the extract, transform, load (ETL) stage 254, which picks up the data from different sources and performs extract, transform and load activities. The data retrieval stage includes then an intermediatory database and/or staging database 256, where the data may be loaded, as an optional step. After the data retrieval stage, the data storage stage may include providing the data to a data storage 258 at the data warehouse. The data warehouse may include raw data, meta data, summary data and the like. Based on the different scenarios possible, the data may be then loaded to a data lake or data mart. The data at the data warehouse may then be reported to an information delivery and reporting platform 260, where analytics may be applied on the data, data mining may be performed, and reports may be generated.

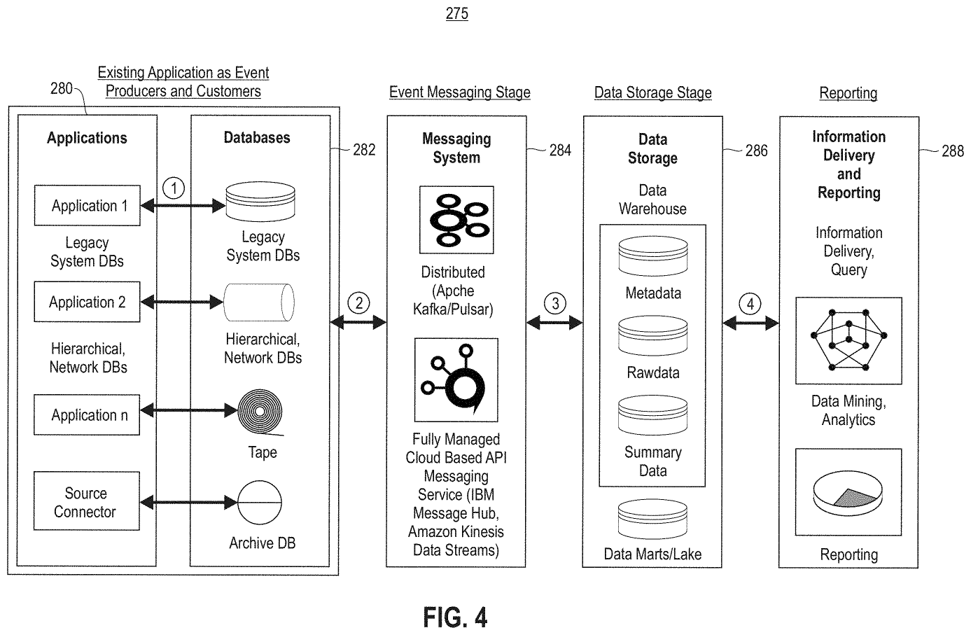

FIG. 4 depicts an alternative architectural pattern 225 for system for estimation of incident management in a data warehouse 100 of FIG. 1, in accordance with embodiments of the present invention. In this architectural pattern, existing applications which use databases are the event producers and consumers. Thus, the architectural pattern 275 includes applications 280, and databases thereof 282 in communication with their respective applications 280. Update application logic is used to publish stage changes as events to a messaging system 284. The producer application may publish events (event header, body, etc.) on topics or content. The application integrates with the messaging system using producer APIs, for example. The source connector may be a kind of producer that enables database changes to be captured as streams and may import data from an existing data store to the messaging system 284. The event message stage 284 may include a distributed messaging system or a fully managed cloud based API messaging system. The event message system may be a fast, scalable and durable real-time messaging engine. When events are produced, the events may be pushed to the messaging system. Subscriber applications may consume the events (transform and/or load). Data then bets loaded to a data warehouse 286. This may be raw data, metadata, summary data, or the like. Based on different scenarios, the data may then get loaded to a data lake or data mart. The data at the data warehouse may then be reported to an information delivery and reporting platform 288, where analytics may be applied on the data, data mining may be performed, and reports may be generated.

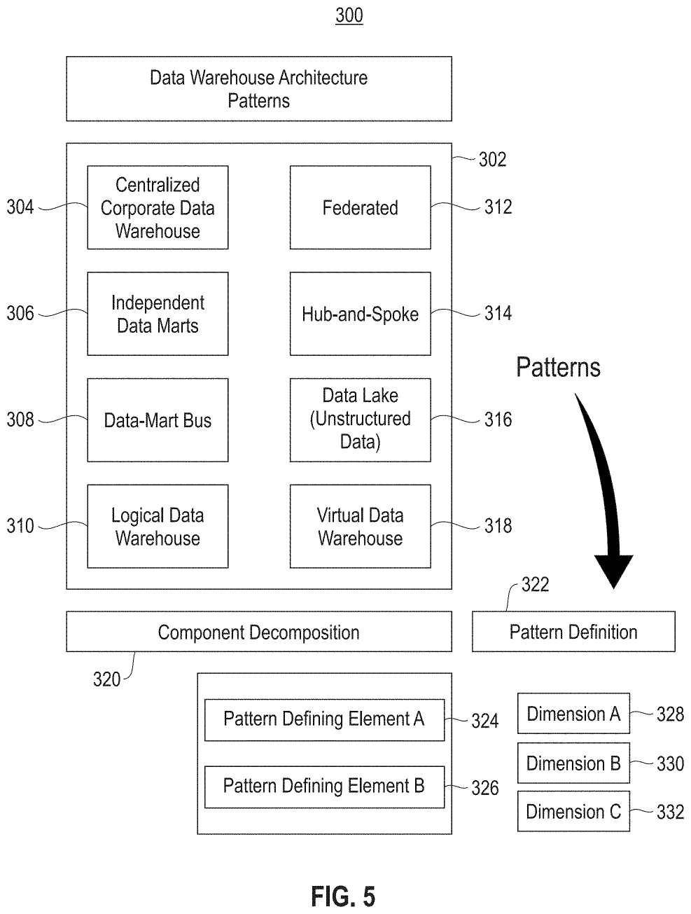

FIG. 5 depicts a component decomposition 300 for the system for estimation of incident management in a data warehouse of FIG. 1 which is used in estimates, in accordance with embodiments of the present invention. The component decomposition 300 shows the various data warehouse architectural patterns 302 that the present systems and methods estimation of incident management in a data warehouse described herein may use. For example, data warehouse architectural patterns 302 may include centralized corporate data warehouses 304, independent data marts 306, data-mart buses 308, logical data warehouses 310, federated data warehouses 312, hub-and-spoke data warehouses 314, data lakes 316 and virtual data warehouses 318. The data warehouse architectural patterns may first be decomposed by a component decomposition 320 by the systems and methods estimation of incident management in a data warehouse described herein including the system estimation of incident management in a data warehouse 100 and/or the computer system 120 and/or the analytics platform 102. The data warehouse architectural patterns may further be defined at a pattern definition process by the systems and methods estimation of incident management in a data warehouse described herein including the system estimation of incident management in a data warehouse 100 and/or the computer system 120 and/or the analytics platform 102. The architectural patterns may include various parameters including pattern defining elements 324, 326 and various dimensions 328, 330, 332, as described herein.

An example embodiment of mathematical modeling consistent with the above-described systems and methods estimation of incident management in a data warehouse described herein will now be described.

The following paragraphs relate specifically to the process of data preparation and correlation identification 204 and the process of cross validated model assessment to predict the volume of tickets 206, as shown in the process flow 200 of FIG. 2. Where X is a collection of measurement vectors and/or features and/or predictors for D deployments. Given D deployments [d₁, d₂, d₃, d₄ . . . ] it is possible to obtain a collection of Vector X=[c₁, c₂, c₃, c₄ . . . ] characteristics of deployments. A ticket prediction model will arrive at a best model to predict V tickets

$$[ \begin{matrix}{v}_{1} \\ {v}_{2} \\ … \\ {v}_{m}\end{matrix} ] ,$$

where v1 is scalar value for deployment 1, and:

$$X - [ \begin{matrix}c \\ {c}_{2} \\ … \\ {c}_{n}\end{matrix} ] … ,$$

where
c_{1,} is a finite Vector with Number of Business Users for similar client deployments
c_{2,} is a finite Vector with kind of business users-operators, Farmers, explorers
c_{3,} is a finite Vector with Number of integrations per client deployments
c_{4,} is the associated complexity, Cyclomatic Complexity (CC) of the Data Ware Housing System e.g. P=e−n+2i
   e is the number of “edges”; internal interfaces and connections between nodes
   n is the number of “nodes”; blocks of function or components
   i is the number of externally connected components; external interfaces
c_{5,} is the pacing rate during Performance Testing for OLAP systems
c_{5,} Elapse Time for Testing
c_{6,} Type of processing per client deployments
c_{7,} is Archicture Pattern for Data Ware House Development
   Hub and Spoke Architcecture
   Federated Architecture
   Data Mart Architecture
c_{8,} is type of Architecture—Tradition Data Ware House Vs event driven architecture being
c_{9,} is platform version being deployed
c_{10,} is a finite Vector with no of associated containers being deployed
c_{11,} is Source of ETL data (Legacy System, heterogeneous data structure (structure/unstructured), network/hierarchical databases, tape, archive data)
c_{12,}: Size of data block
c_{13,} Type of events
c_{14,}—Number of events
c_{15,} Number of event producer applications
c_{16,} Number of event consumer applications
c_{17,} Type of message system (distributed, fully managed cloud based API messaging service)
c_{18,} Number of message system
c_{n,} Other parameter(s)

Using the above framework, feature selection and mathematical modeling can use hyper parameter tuning to select key measurement vectors. Using various value of Legrange multipliers it is possible to select the attributes that are responsible for prediction of tickets for the architecture patterns. It is possible to select the best Φ to minimize the error for prediction by putting the value of c. Next:

$${β}_{ridge} Error = {\sum }_{1}^{N} {y}_{i} - \hat{f ( x )} = {( {\sum }_{1}^{N} {y}_{i} - {θ}_{0} - {\sum }_{j = 1}^{p} {θ}_{j} * {x}_{ij} )}^{2} + Φ {\sum }_{j = 1}^{p} {θ}_{j}^{2} = ( {y}_{i} - {θ}^{T} X ) ( ( {y}_{i} - {θ}_{j} X + Φ {\sum }_{j = 1}^{p} {θ}_{j}^{2}$$

Where the values of:

$${β}_{ridge} = [ \begin{matrix}{β}_{ridge 1} \\ {β}_{ridge 2} \\ {β}_{ridge 2} 3\end{matrix} ] depend on values of Φ$$

Hyper tuning can be performed based on Ridge regression, with: Φ=exp((100:−100)/100) we arrive at the following coefficient pathways.

Next, the maximum likelihood procedure may be leveraged to estimate the prediction:

p(Y|X, θ)=N(Y|f(x), σ²)

=>X ∈ R^{d}, y ∈ R and Y=f(X)+ε where ε=N(0, σ²)
p(Y|X, θ)=N(Y|X, θ, σ²) where x is vector of Random Variables
p(y|X), is the likelihood of probability density function of y at X^{T} and hence

y=X^{T} θ+ε

or yᵢ=θ₀+θ₁x₁+θ₂x₂+θ₃x₃+ . . . eᵢ

p(y|x, θ)=N(y|x, θ, σ²)

Taking Log both sides:

$$- log P ( y {\vert}_{1} x , θ ) … = - log {\prod }_{n = 1}^{N} P ( {y}_{n} \vert {x}_{n} θ ) … taking log both sides = > - log P ( y \vert x , θ ) = - {\sum }_{n}^{N} log P ( {y}_{n} \vert {x}_{n} , θ ) = > L ( θ ) = - log P ( y \vert x , θ ) = - log ( \frac{1}{\sqrt{2 {πσ}^{2}}} * {e}^{( \frac{{( y - {x}^{T θ} )}^{2}}{2 * {σ}^{2}}} ) = > L ( θ ) = - \frac{1}{2 {σ}^{2}} {( {y}_{n} - {X}^{T} θ )}^{2} + {\sum }_{n = 1}^{N} log ( 1 / ( \sqrt{2 * {πσ}^{2} )}$$

Next a batch gradient descent process or a stochastic gradient decent process may be used, where a vector

$$\vec{θ} = [ \begin{matrix}{θ}_{1} \\ {θ}_{2}\end{matrix} ]$$

represent parametric vector and an iteration=0. The initial parameters for learning rate (η) and Epsilon may be input. Next ∇L(\vec{θ}) may be calculated, which is a gradient vector. While ∇L(\vec{θ})>Epsilon: \vec{θ_{N}}₊₁=\vec{θ}_{N}−ηΣᵢ₋₁^{N}{∇L(\vec{θ})^{T}) where N refers to training measurements over X,Y. The optimized value for \vec{θ} is returned when the equation is solved across all N (i.e. set N=N+1 for each operation during the “While” process).

Alternatively, a stochastic gradient decent process may be used, where a vector

$$\vec{θ} = [ \begin{matrix}{θ}_{1} \\ {θ}_{2}\end{matrix} ]$$

represent parametric vector and an iteration=0. The initial parameters for learning rate (η) and Epsilon may be input. Next ΕL(\vec{θ}) may be calculated, which is a gradient vector. While ∇L(\vec{θ})>Epsilon: a random point x may be searched over a training set X, and

$${{θ}^{⟶}}_{{N}_{{+}_{1}}} = {\vec{θ}}_{N} - η * ∇ L ( \vec{θ} )$$

on a random point x generated, where N refers to training measurements. The optimized value for \vec{θ} is returned when the equation is solved across all N (i.e. set N=N+1 for each operation during the “While” process). A “for” loop may be used to move over iterations, instead of a “while” loop as described hereinabove, which would need to stop whenever ∇L(\vec{θ})<Epsilon.

Thus, it is possible to choose the best Φ to reduce the misclassification rate. Hence it is possible to choose the value of β_{ridge} which has lowest misclassification.

A mean square error statistical analysis based on lambda values for feature selection may be used to find a lambda value that lowers mean squared error. This may be used to extract features having the lowest mean squared error. One or more final features may then be selected based on an elastic net regression process.

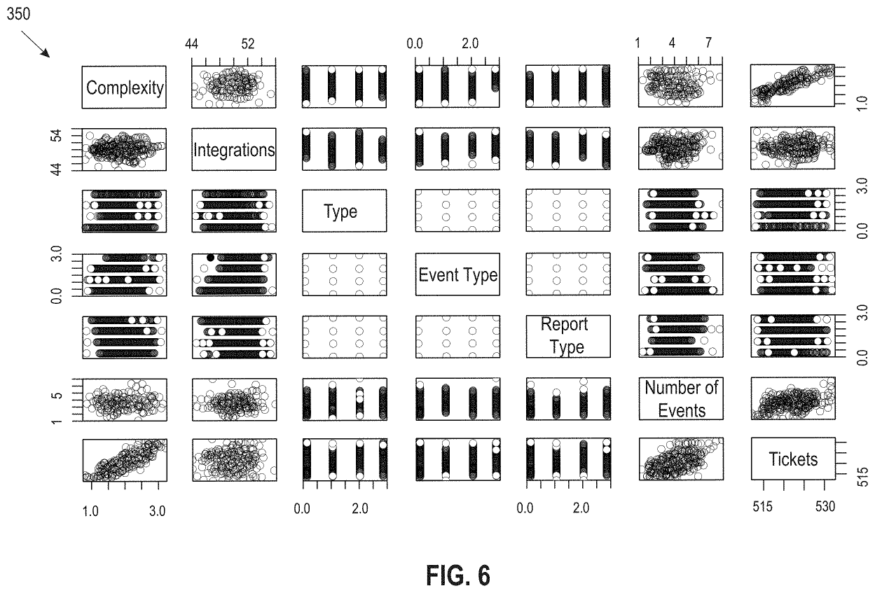

FIG. 6 depicts a scatter plot 350 of historical deployments of the system for estimation of incident management in a data warehouse 100 of FIG. 1, in accordance with embodiments of the present invention. This may be used to identify if there are correlations and if linear regression could be a right fit. Here, the deployment characteristics of complexity, integrations, type, event type, report type, number of events and tickets are shown.

Various linear and log models may be utilized for understanding the variance of error to check for linearity assumption, whereby graphs of residuals vs predicted (fitted) values, scale—location is plotted, a normal q-q plot, or residuals vs leverage are plotted.

Cross-validation is a technique which may also be used to protect against over fitting a predictive model by systems and methods estimation of incident management in a data warehouse described herein. This may be particularly in the case where the amount of data may be limited and it would help to reduce variances in test data (i.e. when a model fits well in training data but not in test data). In order to avoid this, systems and methods estimation of incident management in a data warehouse described herein may use a k-fold cross-validation. This may include, for example:

Model1: Trained on Fold1+Fold2, Tested on Fold3

Model2: Trained on Fold2+Fold3, Tested on Fold1

Model3: Trained on Fold1+Fold3, Tested on Fold2

Statistically, the above refers to the following:

Let there be K folds and CV error for a k-fold item for ω parameters include—

$${E}_{K} = {\sum }_{i ϵ k}^{K} {( {y}_{i} - {x}_{i} β ( ω ) )}^{2}$$

Where the above provides a cross validation of i in fold k. Since there are a total of k folds, it is possible to arrive at the number as below:

$$CV ( ω ) = 1 / K$$

$${\sum }_{k = 1}^{K} {E}_{K} ( ω )$$

Next, it is possible to create a matrix of different models and CV. The table exists as below:

$$CV = [ \begin{matrix}{cv}_{1} \\ {cv}_{2} \\ … \\ {cv}_{m}\end{matrix} ]$$

where 1 . . . m represent model associations and CV provides cross validation values for different models. Finally, it is possible to select the best model based on a minimal CV value and choose the model k.

The following paragraphs relate specifically to the process of leveraging a TREI search engine to find resources, cost and mean time to resolve 214, as shown in the process flow 200 of FIG. 2. Here, selecting the set of resources with the best skill set from a list of candidates using a decision tree algorithm (TRIE algorithm). A TRIE is a data structure used to store strings that can be visualized like a graph. It may be an efficient information retrieval data structure based on the prefix of a string. A TRIE algorithm or structure consists of nodes and edges. Each node consists, for example, of a maximum of 26 children. Edges connect each parent node to its children. Various data attributes may be inserted into a TRIE algorithm in accordance with the present invention, including:

Skill Set

Mean Time to Resolve (MTR)

Qualification

Cost

Resource Name

Technology Experience

Relevant Experience

The prefix of a string is nothing but any n letters n≤|S| that can be considered beginning strictly from the starting of a string. For example, the word cost has the following prefixes:

C

Co

Cos

Cost

The Root node above may be “C”. The insertion of any string into a Trie starts from the root node. All prefixes of length one are direct children of the root node. In addition, all prefixes of length 2 become children of the nodes existing at level one. The pseudo code for insertion of a string into a TRIE structure would look as follows:
Void INSERT (String word[COST])
1. Make current node points to the root [C] of the TRIE.
2. For each character C, O, S, T in word:

Get the pre-determined position for C, O, S, T in the children array

If the children node of the current node has nothing at that position, insert C, O, S, T

Make current node points to its child node whose index is the same as position.
3. Set leaf Node to true to indicate insertion of word into the TRIE.
   Boolean SEARCH (String word [COST])
1. Make current node points to the root of the TRIE.
2. For each character in C, O, S, T word:

If there is nothing in current node, return false.

Get the pre-determined position for C, O, S, T in the children array

Make current node points to its child node whose index is the same as position.
3. If current node is not empty and leafNode is false, return false.
4. Return true to indicate that word was found in the TRIE.

TRIE structures may be particularly useful for use by the systems and methods estimation of incident management in a data warehouse described herein and may be particularly advantageous over other data structures such as Binary Tree, Binary Search Trees and Hashing, although the present invention does contemplate the use of other data structures than TRIE structures. TRIE structures can insert and find strings in a faster time than Binary search trees and Hashing, for example, because no hash function is needed to be computed and no collision handling is required. Words can easily be printed in alphabetical order, and it is efficient to perform a prefix search with TRIE structures.

Overall, the output of the process of leveraging a TREI search engine to find resources, cost and mean time to resolve 214, as shown in the process flow of FIG. 2 may be a range of skill sets {S1, S2, S3} which will give a cost rate {C1, C2, C3 . . . } with effort estimates for High priority tickets {t1, t2, t3}.

The following paragraphs relate specifically to the process of using a resource model to calculate the best model for mean time to resolve 216, as shown in the process flow 200 of FIG. 2. Here, model preparation to estimate hours of work for highly critical tickets for an application may be prepared. Leveraging the following equations from above:

$${β}_{ridge} Error = {\sum }_{1}^{N} {y}_{i} - \hat{f ( x )} = {( {\sum }_{1}^{N} {y}_{i} - {θ}_{0} - {\sum }_{j = 1}^{p} {θ}_{j} * {x}_{ij} )}^{2} + Φ {\sum }_{j = 1}^{p} {θ}_{j}^{2} \qquad ( 1 )$$

$$L ( θ ) = - \frac{1}{2 {σ}^{2}} {( {y}_{n} - {X}^{T} θ )}^{2} + {\sum }_{n = 1}^{N} log ( 1 / ( \sqrt{2 * {πσ}^{2} )} \qquad ( 2 )$$

$${{θ}^{⟶}}_{{N}_{{+}_{1}}} = {\vec{θ}}_{N} - η {\sum }_{i - \text{.1}}^{N} \{ ∇ {L ( \vec{θ} )}^{T} ) \qquad ( 3 )$$

where N refers to training measurements over X,Y it is possible to once again arrive at time taken by individuals to solve defects. We can denote this by function f(t):

t=f(b₁, b₂, b₃, b₄) where:
b₁=cost rate of engineer as obtained from the previous process flow 214
b₂=Skill Set of Engineer
b₃=qualification of engineer
b₄=Number of years of experience of engineer
   Thus, it is likely that since all the variables are dependent, there will be a high correlation and VIF>10 and hence a product of variables would be the better model. Using the above equations (1), (2), (3), it is possible to choose the best model leveraging cross validation machine learning techniques and model assessment. The time taken per resource may be a function of c:

t=Ab₁+bb₂+cb₃²*m

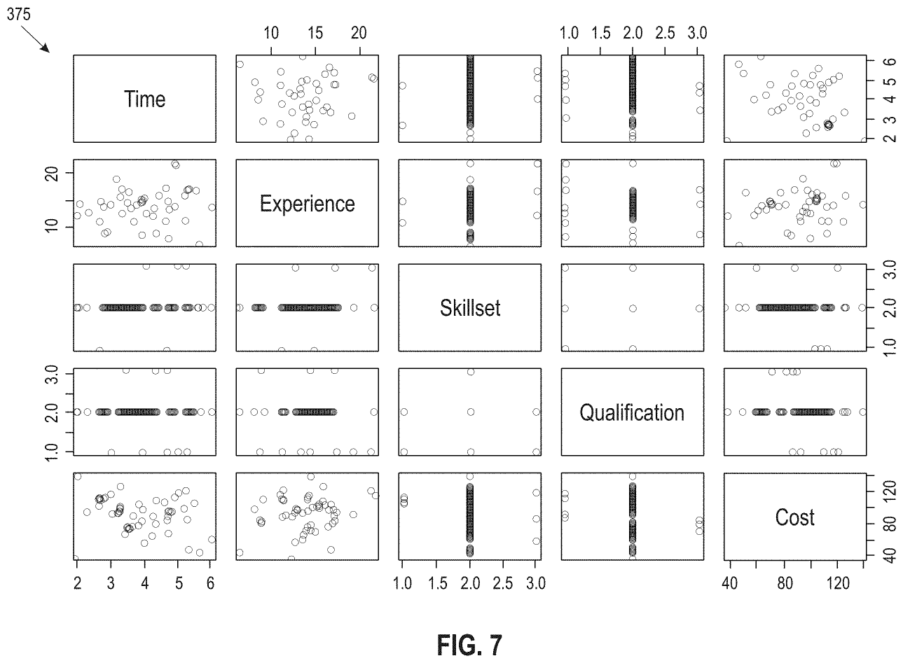

FIG. 7 depicts characteristics 375 of resources from similar deployments to reduce tickets resolution time for a newly deployed application, in accordance with embodiments of the present invention. The resources include Time, Experience, Skillset, Qualification and Cost. This may provide for a scatter plot of resources extracted after a TRIE alrgoirhtm of all software engineers who have worked in similar deployments is included. This scatter plot example may be used to identify if there are correlations and if a particular model could be a right fit.

The following paragraphs relate specifically to the process of optimization of a platform to identify patterns or characteristics among resources to optimize (minimize) mean time to resolution for critical tickets 210, as shown in the process flow 200 of FIG. 2. Here, combining the most recent equation:

t=Ab₁+bb₂+cb₃²*m

with either the above equation (3) \vec{θ_{N}}₊₁=\vec{θ}_{N}−ηΣᵢ₋₁^{N} {∇L(\vec{θ})^{T}), where N refers to training measurements over X,Y (when using a Batch gradient descent process), or the equation: \vec{θ_{N}}₊₁=\vec{θ}_{N}−η*∇L(\vec{θ}) on a random point x generated (when using a stochastic gradient process) it is possible to arrive at a cost function z=f(V)*f(t). Thus, we arrive at:

z=f(t)=Ab₁+bb₂+cb₃²*m*(α)

assuming cost rate r is a continuous function, we can find the global minima and global maxima for z:

$$Min ( Z ) = \frac{\partial }{\partial m} ( z ) + \frac{\partial }{\partial r} ( z ) + \frac{\partial }{\partial r} ( z ) + \frac{\partial }{\partial a} ( z ) + \frac{\partial }{\partial b} ( z ) = 0$$

Then the values of minima can be obtained by double differentiating to arrive at a best optimized value rate, number of business, experience and other variables. In the case of constraints, it is possible to use Lagrange multipliers as well.

A gradient search may also be performed. Here, all algorithms for unconstrained gradient-based optimization can be described by starting with iteration number=−and a starting point x. First convergence may be tested for. If the conditions for convergence are satisfied, then it is possible to stop and xₖ is the solution. If not, the next step is to compute a search direction and compute the vector pₖ that defines the direction in space along which the gradient search will be performed. Next a step length can be computed, finding a positive scalar αₖ such that f(xₖ+αpₖ)<f(xₖ). Finally, updating the design variables is possible, setting xₖ+1=xₖ+αk pk, k=k+1 and thereby go back to 1·xk+1=x k+αkp.

Using a Naive multi-start approach, it would be given that we have a range of characteristic resources [bᵢ₁, bᵢ₂, bᵢ₃, bᵢₚ]. Using this approach, the first step would be to choose the random sample i among different p characteristics of resources. Starting a local search at the point and returning the coordinates and function value of lowest minimum and using this within the boundary of a client's request may be performed. Based on Naïve multi start approach it is possible to take a sample point with 100,10,2 representing Cost, Years of experience & Skill Set at starting point. It is then possiblie to create a Contour plot of Time to Resolution or Cost of Resource. It is also possible to then plot a contour map of Mean Time to Resolve Tickets Vs Cost and experience. Then it is possible to find the local minima which is where the lowest cost resource that can solve the tickets in allocated time is found. This may arrive at a “mean time of resolution” and at resources with key characteristics, cost, years of experience and skill set as a “winning” combination to support the client with a minimum resolution time.

The following paragraphs relate specifically to the process of finding resources from a pool of candidates based on agreed upon characteristics 212, as shown in the process flow 200 of FIG. 2. Here, it Is possible to find all candidates required to support the application using b characteristics to support the client. In an exemplary case, it is possible to find the particular candidates with the proper (or found in the previous process 210) “winning” combination of key characteristics, cost, years of experience and skill set, as found above. Here, a TRIE algorithm may once again be leveraged to find resources in a database, where the resources have the optimum characteristics to satisfy the “winning” combination. If the optimum resource is not available, it is possible to find the next best resource for application support.

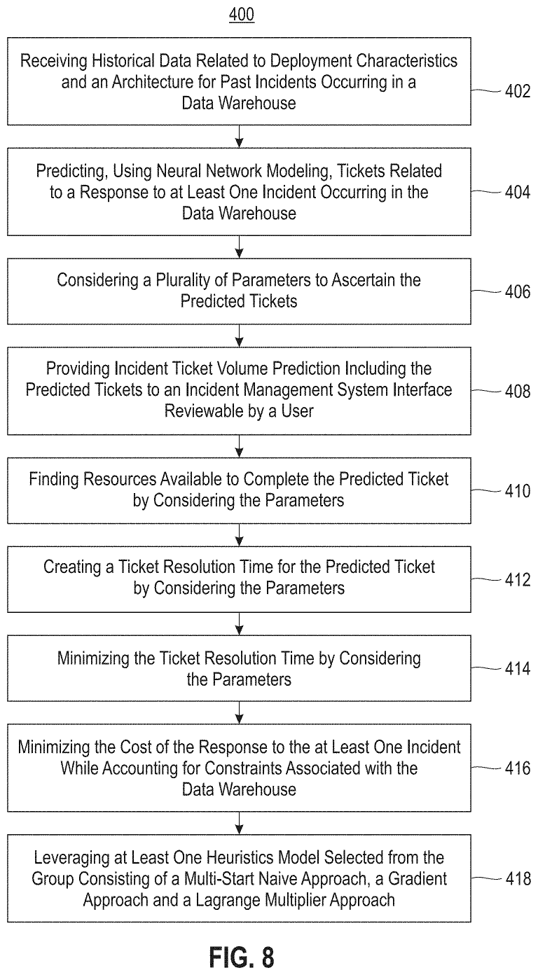

FIG. 8 depicts detailed method 400 of how a solution estimate works based on past data, in accordance with embodiments of the present invention. The method 400 includes a first step 402 of receiving, by one or more processors of a computer system such as the computer system 120, historical data related to deployment characteristics and an architecture for past incidents occurring in a data warehouse. The method 400 may include a next step 404 of predicting, by the one or more processors of the computer system using neural network modeling, tickets related to a response to at least one incident occurring in the data warehouse. The predicting may be based on the deployment characteristics and the architecture of the data warehouse. The method may include a next step 406 of considering, by the one or more processors of a computer system, a plurality of parameters to ascertain the predicted tickets. The parameters may include a plurality of parameters selected from the group consisting of type of architecture, type of users, cyclomatic complexity, performance time elapsed, number of integrations, number of data marts, retrieval strategy, number of transactions in a given time period, type of interactions, type of data presentation, type of data marts, number of technical components, source of extract-load-transform data, size of data block, number of events, number of event producer applications, and number of message systems. The method 400 may include another step 408 of providing, by the one or more processors of the computer system, incident ticket volume prediction including the predicted tickets to an incident management system interface reviewable by a user.

The method 400 may include a step 410 of finding, by the one or more processors of the computer system, resources available to complete the predicted tickets by considering the parameters. The parameters include at least one parameter selected from the group consisting of skill, qualification, time taken, tickets, and resource type. The method 400 may include a step 412 of creating, by the one or more processors of the computer system, a ticket resolution time for the predicted tickets by considering the parameters. The parameters here may include at least one parameter selected from the group consisting of skill, qualification, time taken, tickets, and resource type.

Still further, the method 400 may include a step 414 of minimizing, by the one or more processors of the computer system, the ticket resolution time by considering the parameters. Here, the parameters may include at least one parameter selected from the group consisting of probability of severity of tickets, volume of tickets, and average time taken by a pool of resources. Still further, the method 400 may include a step 416 of minimizing, by the one or more processors of the computer system, the cost of the response to the at least one incident while accounting for constraints associated with the data warehouse. Finally, the method 400 may include a step 418 of leveraging, by the one or more processors of the computer system, at least one heuristics model selected from the group consisting of a multi-start naïve approach, a gradient approach and a Lagrange multiplier approach.

Additional method steps are contemplated herein that are consistent with the functionality, processes and methodology described hereinabove with respect to the systems and methods estimation of incident management in a data warehouse described herein including the system estimation of incident management in a data warehouse 100 and/or the computer system 120 and/or the analytics platform 102.

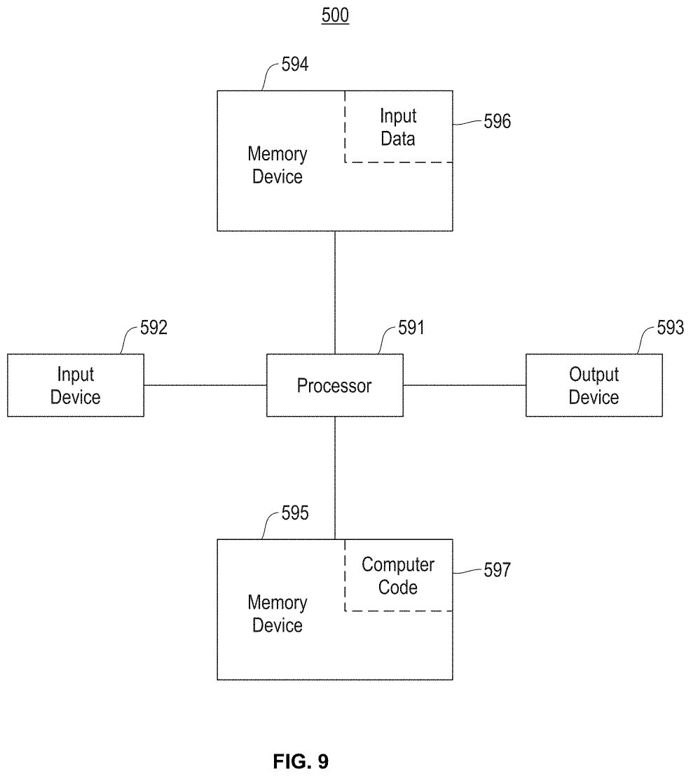

FIG. 9 depicts a block diagram of an exemplary computer system that may be included in the system estimation of incident management in a data warehouse of FIG. 1, capable of implementing process flows and methods estimation of incident management in a data warehouse of FIGS. 2 and 8, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing methods and processes estimation of incident management in a data warehouse in the manner prescribed by the embodiment in FIGS. 2 and 8 using one, some or all of the system estimation of incident management in a data warehouse 100 of FIG. 1, wherein the instructions of the computer code 597 may be executed by processor 591 via memory device 595. The computer code 597 may include software or program instructions that may implement one or more algorithms for implementing the methods and processes estimation of incident management in a data warehouse, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 4.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a computing device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from one or more computer data storage units (not shown). The one or more computer data storage units include a known computer-readable storage medium, which is described below. In one embodiment, the one or more computer data storage units may be a non-volatile data storage device, such as a magnetic disk drive (i.e., hard disk drive) or an optical disc drive (e.g., a CD-ROM drive which receives a CD-ROM disk). In other embodiments, the one or more computer data storage unit may include a knowledge base or data repository 125, such as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to identification validation systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to perform methods estimation of incident management in a data warehouse described herein. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements the methods estimation of incident management in a data warehouse described herein. Thus, the present invention discloses a process for supporting, deploying and/or integrating computer infrastructure, integrating, hosting, maintaining, and deploying computer-readable code into the computer system 500, wherein the code in combination with the computer system 700 is capable of performing the methods estimation of incident management in a data warehouse described herein.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

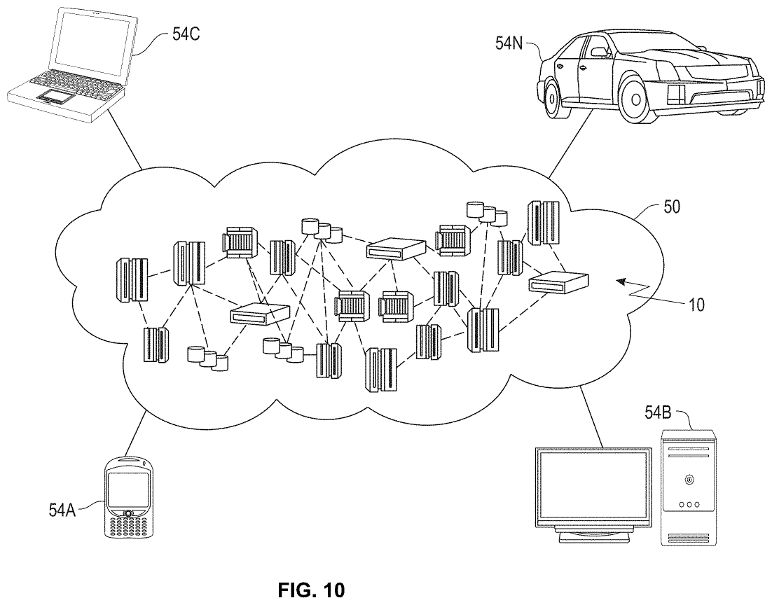

Referring now to FIG. 10, illustrative cloud computing environment 50 is depicted. As shown, cloud computing environment 50 includes one or more cloud computing nodes 10 with which local computing devices used by cloud consumers or users, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 10 are intended to be illustrative only and that computing nodes 10 and cloud computing environment 50 can communicate with any type of computerized device over any type of network and/or network addressable connection (e.g., using a web browser).

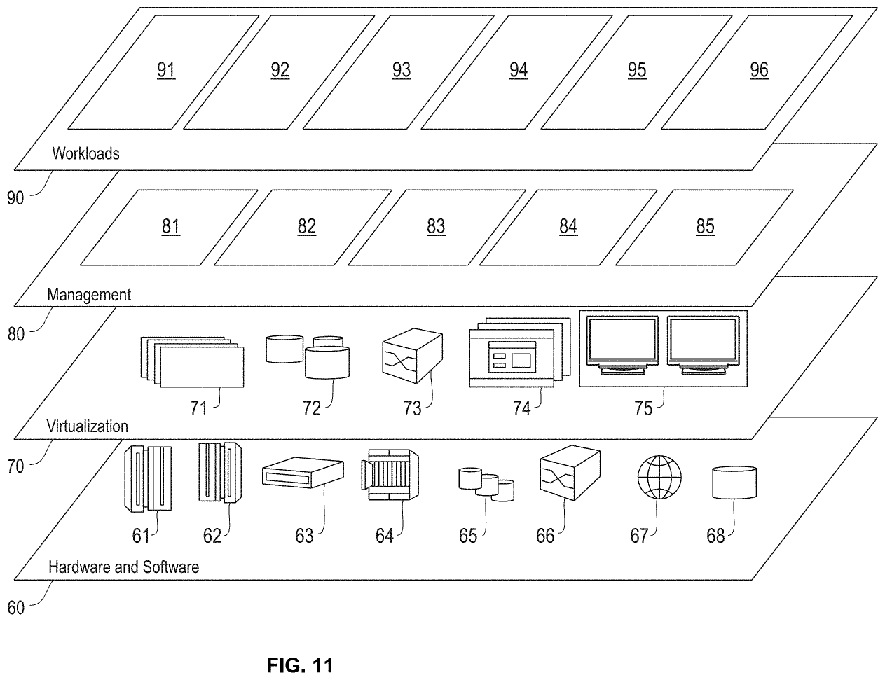

Referring now to FIG. 11, a set of functional abstraction layers provided by cloud computing environment 50 (see FIG. 10) are shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: import and export 91; continuous feedback 92; dynamic updates 93; cognitive or neural processing 94; component decomposition 95; pattern definition 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving, by one or more processors of a computer system, historical data related to deployment characteristics and an architecture for past incidents occurring in a data warehouse;
predicting, by the one or more processors of the computer system using neural network modeling, tickets related to a response to at least one incident occurring in the data warehouse, wherein the predicting is based on the deployment characteristics and the architecture of the data warehouse;
considering, by the one or more processors of a computer system, a plurality of parameters to ascertain the predicted tickets; and
providing, by the one or more processors of the computer system, incident ticket volume prediction including the predicted tickets to an incident management system interface reviewable by a user.

2. The method of claim 1, further comprising:
finding, by the one or more processors of the computer system, resources available to complete the predicted tickets by considering the parameters, wherein the parameters include at least one parameter selected from the group consisting of skill, qualification, time taken, tickets, and resource type.

3. The method of claim 2, further comprising:
creating, by the one or more processors of the computer system, a ticket resolution time for the predicted tickets by considering the parameters, wherein the parameters include at least one parameter selected from the group consisting of skill, qualification, time taken, tickets, and resource type.

4. The method of claim 3, further comprising:
minimizing, by the one or more processors of the computer system, the ticket resolution time by considering the parameters, wherein the parameters include at least one parameter selected from the group consisting of probability of severity of tickets, volume of tickets, and average time taken by a pool of resources.

5. The method of claim 1, wherein the parameters include a plurality of parameters selected from the group consisting of type of architecture, type of users, cyclomatic complexity, performance time elapsed, number of integrations, number of data marts, retrieval strategy, number of transactions in a given time period, type of interactions, type of data presentation, type of data marts, number of technical components, source of extract-load-transform data, size of data block, number of events, number of event producer applications, and number of message systems.

6. The method of claim 1, further comprising:
minimizing, by the one or more processors of the computer system, the cost of the response to the at least one incident while accounting for constraints associated with the data warehouse.

7. The method of claim 1, further comprising:
leveraging, by the one or more processors of the computer system, at least one heuristics model selected from the group consisting of a multi-start naive approach, a gradient approach and a Lagrange multiplier approach.

8. A computer system, comprising:
one or more processors;
one or more memory devices coupled to the one or more processors; and
one or more computer readable storage devices coupled to the one or more processors, wherein the one or more storage devices contain program code executable by the one or more processors via the one or more memory devices to implement a method estimation of incident management in a data warehouse, the method comprising:
receiving, by the one or more processors of the computer system, historical data related to deployment characteristics and an architecture for past incidents occurring in a data warehouse;
predicting, by the one or more processors of the computer system using neural network modeling, tickets related to a response to at least one incident occurring in the data warehouse, wherein the predicting is based on the deployment characteristics and the architecture of the data warehouse;
considering, by the one or more processors of a computer system, a plurality of parameters to ascertain the predicted tickets; and
providing, by the one or more processors of the computer system, incident ticket volume prediction including the predicted tickets to an incident management system interface reviewable by a user.

9. The computer system of claim 8, the method further comprising:
finding, by the one or more processors of the computer system, resources available to complete the predicted tickets by considering the parameters, wherein the parameters include at least one parameter selected from the group consisting of skill, qualification, time taken, tickets, and resource type.

10. The computer system of claim 9, the method further comprising:
creating, by the one or more processors of the computer system, a ticket resolution time for the predicted tickets by considering the parameters, wherein the parameters include at least one parameter selected from the group consisting of skill, qualification, time taken, tickets, and resource type.

11. The computer system of claim 10, the method further comprising:
minimizing, by the one or more processors of the computer system, the ticket resolution time by considering the parameters, wherein the parameters include at least one parameter selected from the group consisting of probability of severity of tickets, volume of tickets, and average time taken by a pool of resources.

12. The computer system of claim 8, wherein the parameters include a plurality of parameters selected from the group consisting of type of architecture, type of users, cyclomatic complexity, performance time elapsed, number of integrations, number of data marts, retrieval strategy, number of transactions in a given time period, type of interactions, type of data presentation, type of data marts, number of technical components, source of extract-load-transform data, size of data block, number of events, number of event producer applications, and number of message systems.

13. The computer system of claim 8, the method further comprising:
minimizing, by the one or more processors of the computer system, the cost of the response to the at least one incident while accounting for constraints associated with the data warehouse.

14. The computer system of claim 8, the method further comprising:
leveraging, by the one or more processors of the computer system, at least one heuristics model selected from the group consisting of a multi-start naive approach, a gradient approach and a Lagrange multiplier approach.

15. A computer program product for incident management of a data warehouse, the computer program product comprising:
one or more computer readable storage media having computer readable program code collectively stored on the one or more computer readable storage media, the computer readable program code being executed by one or more processors of a computer system to cause the computer system to perform a method comprising:
receiving, by one or more processors of a computer system, historical data related to deployment characteristics and an architecture for past incidents occurring in a data warehouse;
predicting, by the one or more processors of the computer system using neural network modeling, tickets related to a response to at least one incident occurring in the data warehouse, wherein the predicting is based on the deployment characteristics and the architecture of the data warehouse;
considering, by the one or more processors of a computer system, a plurality of parameters to ascertain the predicted tickets; and
providing, by the one or more processors of the computer system, incident ticket volume prediction including the predicted tickets to an incident management system interface reviewable by a user.

16. The computer program product of claim 15, the method further comprising:
finding, by the one or more processors of the computer system, resources available to complete the predicted tickets by considering the parameters, wherein the parameters include at least one parameter selected from the group consisting of skill, qualification, time taken, tickets, and resource type.

17. The computer program product of claim 16, the method further comprising:
creating, by the one or more processors of the computer system, a ticket resolution time for the predicted tickets by considering the parameters, wherein the parameters include at least one parameter selected from the group consisting of skill, qualification, time taken, tickets, and resource type.

18. The computer program product of claim 17, the method further comprising:
minimizing, by the one or more processors of the computer system, the ticket resolution time by considering the parameters, wherein the parameters include at least one parameter selected from the group consisting of probability of severity of tickets, volume of tickets, and average time taken by a pool of resources.

19. The computer program product of claim 15, wherein the parameters include a plurality of parameters selected from the group consisting of type of architecture, type of users, cyclomatic complexity, performance time elapsed, number of integrations, number of data marts, retrieval strategy, number of transactions in a given time period, type of interactions, type of data presentation, type of data marts, number of technical components, source of extract-load-transform data, size of data block, number of events, number of event producer applications, and number of message systems.

20. The computer program product of claim 15, the method further comprising:
minimizing, by the one or more processors of the computer system, the cost of the response to the at least one incident while accounting for constraints associated with the data warehouse; and
leveraging, by the one or more processors of the computer system, at least one heuristics model selected from the group consisting of a multi-start naive approach, a gradient approach and a Lagrange multiplier approach.
